(19) United States
(12) Patent Application Publication
(10) Pub. No.: US 2025/0034805 A1
(43) Pub. Date: Jan. 30, 2025

(54) PHYSICAL REUTILIZATION OF SILICONIZED PAPERS

(71) Applicant: Evonik Operations GmbH, Essen (DE)

(72) Inventors: Wilfried Knott, Essen (DE); Horst Dudzik, Essen (DE)

(73) Assignee: Evonik Operations GmbH, Essen (DE)

(21) Appl. No.: 18/784,202

(22) Filed: Jul. 25, 2024

(30) Foreign Application Priority Data
Jul. 27, 2023 (EP) 23188062.6

(51) Int. Cl. D21C 5/02; D21C 9/02; D21C 9/18

(52) U.S. Cl. CPC D21C 5/022; D21C 9/02; D21C 9/18

(57) ABSTRACT

A method for the physical reutilization of siliconized papers includes at least a first step (a), treating at least one siliconized paper by contacting it with at least one alcohol and at least one alkali metal alkoxide with introduction of heat, and without removing from the reaction mixture any water that occurs, and then, a second step (b), removing the at least one desiliconized paper resulting from the first step (a) from the optionally previously neutralized reaction mixture.

### CROSS-REFERENCE TO RELATED APPLICATIONS

This application claims priority to European Patent Application No. 23188062.6, filed on Jul. 27, 2023, the content of which is hereby incorporated by reference in its entirety.

### BACKGROUND

### Field of the Invention

The present invention is situated in the field of silicones and siliconized papers, and is concerned in particular with the physical reutilization of siliconized papers.

The silicone coating of certain sheetlike structures, more particularly both paper and polymeric sheetlike structures, is known practice in order to modify the surface of the sheetlike structure, so as to generate a non-stick surface, for example. These are then referred to as siliconized sheetlike structures, i.e. siliconized sheetlike structures are silicone-coated sheetlike structures. Silicone-coated papers or polymeric films of this kind are available on the market for a variety of end uses.

Silicone-coated paper, also referred to as siliconized paper in the context of this invention, can be used, for example, as base paper for pressure-sensitive adhesive labels, self-adhesive films and self-adhesive tapes or as release paper for PVC film manufacture. This coated paper accumulates in considerable quantities at the premises both of manufacturers and of users, and by far the largest proportion of this paper, after having fulfilled its function, is sent to landfill or disposed of thermally—that is, incinerated. To date, only in exceptional cases have lower-quality papers been produced from these papers, for packaging uses.

### Description of Related Art

The significance of this topic for the goal of a circular economy is apparent, for example, from production figures for the years 2008 and 2010, taken from the PTS (Papiertechnische Stiftung) Research Report IGF_16407, Development of a coating concept for producing silicone release papers using the multi-layer curtain coater technology, by M. Stäubner and H. Schmid, www.ptspaper.de. The report reads as follows on page 6: “The 2008 worldwide production volume of 33.7 billion m² of release paper was increased in 2010 to only 33.98 billion m². Of this, 52% in 2008 and 51.5% in 2010 were utilized for labels alone.”

The prior art refers to various efforts towards the recycling of silicone-coated papers. For instance, the teaching of EP 0587000 A1 claims a method for recycling silicone-coated paper in flotation deinking apparatuses, using 10% strength sodium hydroxide solution, by beating and reforming sheets, that method being characterized in that the beating is carried out in the presence of one or more salts of phosphoric esters of fluorinated alkanols. According to the teaching, the use of these exotic process auxiliaries is necessary in order to avoid typical problems in the alkaline recycling process, such as poor pulp dissolution, incomplete resin dispersion, and the formation of resin agglomerates and the associated risk of sticking on cylinder surfaces and felts.

A further process for the recycling of silicone-coated, cellulose-based and/or polymeric carrier systems is claimed by the company Reculiner (Belgium) in EP 2542728 B1, but is geared solely to their utilization as materials. Here, for example, silicone-coated release paper waste is utilized for cellulose fibre insulation (CFI), employed for heat insulation and soundproofing in the construction sector. The release paper is treated for example with flame retardants and is thereafter processed into lightweight flakes, using specially developed equipment. The accompanying claim is that one of the most important advantages of the cellulose fibre insulation obtained not from conventional waste paper (such as newspapers, for example) but instead from a release paper of this kind lies in the greater elasticity of the fibres it contains. This property is said then to result in better fixation, meaning an improved resistance to the possible sinking of the insulating material following its blown injection into a cavity wall. By comparison with the traditional cellulose fibre insulation, obtained preferably from old newspapers, a further improvement on the part of the RecuLiner material is said to lie in its increased flowability, making it easier to apply.

WO2022/086456 A1 teaches a process for deinking and for desiliconizing paper products comprising the steps of pulp screening and treating the paper with an aqueous solution comprising alkylene glycol ether, sodium hydroxide, sodium silicate, hydrogen peroxide and a surfactant. In accordance with the procedure of EP 0587000 A1, the silicone-removing step is effected using flotation in order to transport the silicone detached from the paper surface, and also the printing ink, to the surface of the aqueous digestion solution by way of controlled introduction of air. The removed printing ink and the removed silicone are then disposed of for example by incineration.

WO2022/086456 A1 shows that the two-stage flotation process is only suitable for paper waste consisting predominately, i.e. to an extent of 70 percent by weight or more, of used printing and writing paper and to an extent of at most 30 percent by weight or preferably less of silicone-coated paper, since otherwise there will be operationally disruptive, mechanical blockages in the line system of the paper processing plant. The multi-phase, aqueous digestion system here must be precisely adjusted with respect to the feedstocks used and the effective concentrations thereof in order to achieve good results both in terms of printing ink removal and desiliconization. The residual silicone contents of less than 100 ppm which can then be achieved by the method under optimal conditions allow the recycled paper to be used as printing paper.

EP3885096 A1 describes a method for the physical reutilization of siliconized sheetlike structures, in particular siliconized papers or siliconized polymeric films, where the siliconized sheetlike structure is treated in a liquid digestion system comprising acetic anhydride and/or an acetoxysiloxane, and at least one Brønsted acid, optionally solvent, and preferably acetic acid. The desiliconization in this specific organic matrix proceeds very effectively, however the use of Brønsted acids, in this case in particular of sulfuric acid or of organic sulfonic acids, is always associated with the drawback of isolating a desiliconized paper that is discoloured to a lesser or greater extent after the liquid organic phase has been removed.

In view of this prior art, it remains fundamentally desirable to provide an efficient desiliconization method which combines for example the advantages of effective silicone removal from exclusively silicone-coated paper, as disclosed in EP 3885096 A1, with the additional benefit of recovering the desiliconized paper carrier with as little discolouration as possible.

Equally, it would also be desirable if a desiliconization method could also offer the possibility of reusing the siloxane constituents originating from the coating, with the result that the silicone-coated paper could be physically reutilized to a large extent.

In Zh. Obshch. Khim. 1959, 29, 1528-1534 (Russian Journal of General Chemistry 1959, 29, 1528-1534), Vornokov and Shabarova describe the production of organoalkoxysilanes by cleavage of organosiloxanes with C4 to C12 alcohols under basic conditions, with use being made of alkali metal hydroxides, alkali metal alkoxides or the alkali metals themselves. The authors interpret the reaction of the organosiloxane with alcohol as an equilibrium reaction where it is important to remove water of reaction from the reaction system azeotropically or using an inert, water-insoluble solvent or else preferably by addition of silicic esters (tetralkoxysilanes) as dehydrating agents. Without the use of dehydrating reagents, it is then not possible either to produce alkoxysilanes derived from alcohols having boiling points below 90° C. or to obtain high yields of alkoxysilanes. By contrast, the publication does not provide any solution for the production of alkoxysiloxanes since, as is understood by those skilled in the art, especially any remaining high-boiling tetraalkoxysilanes (for example tetraethoxysilane with b.p. 168° C.) and the condensation products resulting therefrom would entail a considerable separation and purification effort.

The as yet unpublished European patent application having the application reference 22190105.1 describes a novel method for recycling waste silicones, such as old sprue and/or stamping waste from silicone rubber production or discarded electronic scrap containing silicone-sealed components/component groups, by the chemical transformation thereof into siloxanes containing alkoxy groups, where the waste silicone is thermally reacted with an alkali metal alkoxide and an alcohol without removing any water that occurs, and the reaction mixture resulting from this reaction is neutralized in a second step using a Brønsted acid, possibly also with addition of a solvent, then the solid constituents are separated off, especially by filtration, and then the alkoxysiloxane is isolated by thermal separation of volatile compounds.

However, the recycling of siliconized sheetlike structures such as siliconized papers is not disclosed in said document.

### SUMMARY OF THE INVENTION

Against this background, the object of the present invention to specifically be achieved was to provide a method for the physical reutilization of siliconized papers with the aim of being able to recover the desiliconized paper with as little discolouration as possible. The specific object of the invention is achieved by the subject matter of the invention.

The invention provides a method for the physical reutilization of siliconized papers, comprising at least the following steps:
first step (a): treating at least one siliconized paper by contacting it with at least one alcohol and at least one alkali metal alkoxide with introduction of heat, and without removing from the reaction mixture any water that occurs, preferably without the use of solvents that form azeotropes with water and/or without the use of further dehydrating agents,
and then,
second step (b): removing the at least one desiliconized paper resulting from the first step (a) from the optionally previously neutralized reaction mixture.

This therefore opens up the pathway to physical reuse of the respective siliconized papers, which makes it possible to be able to recover the desiliconized paper with as little discolouration as possible.

The method according to the invention provides the treatment of at least one siliconized paper. The siliconized papers usable in the method according to the invention in particular also include all siliconized papers known on the market. Both papers and siliconized papers are well known to those skilled in the art. Papers are the sheetlike materials known to those skilled in the art which are producible in a manner known to those skilled in the art usually from fibrous materials, such as in particular mechanical pulps, waste paper pulp and/or chemical pulp.

In the context of this invention, siliconized papers are all papers which have a silicone coating. These may be papers that are coated with silicone on one side or both sides. Such siliconized papers are known to those skilled in the art; they are commercially available and are widespread on the market, for example as release papers or e.g. also as packaging papers in the packaging of food.

The type of the silicone coatings is not critical and encompasses all silicone coatings which are known on the market and suitable for coating papers, in particular the established, solvent-free or solvent-containing, platinum-catalyzed systems, but also UV-activated systems with radical or cationic polymerization which are easy to process.

### DETAILED DESCRIPTION OF THE INVENTION

Preferably, the term “siliconized paper” in the context of this invention means single- or double-sidedly silicone-coated paper in which the silicone coating preferably fulfils the function of a release coating.

Preferred silicone coatings in the context of the present invention are consequently release coatings made of silicone or silicone materials.

Release coatings made of silicone or silicone materials are known from the prior art and are described in the patent literature, for example in WO2020126655A1. They may find use, for example, in label laminates. They may preferably serve to protect tacky surfaces from soiling or unintended sticking. For example, release coatings may be used especially in the case of papers in order to reduce the tendency of adhering products to adhere to these papers.

The silicone coatings, preferably release coatings composed of silicone or silicone materials, may be produced in a customary manner known from the prior art; they may preferably be produced from one or more organosiloxanes by crosslinking.

The crosslinking can preferably be effected thermally via a hydrosilylation reaction between a compound having SiH groups and an ethylenically unsaturated compound, preferably in the presence of a catalyst, preferably at relatively high temperatures of generally, for example, above 100° C.

For example, it is alternatively also possible to produce the silicone coatings preferably by crosslinking of silicones having ethylenically unsaturated, free-radically polymerizable groups by irradiation with high-energy radiation or thermally in the presence of suitable initiators or free-radical initiators.

Organosiloxanes usable with preference are, for example, silicones having ethylenically unsaturated, free-radically polymerizable groups, for example (meth)acrylate-modified organosiloxanes. (Meth)acrylate-modified organosiloxanes are well known to the person skilled in the art and are described in numerous patent specifications, for example in U.S. Pat. Nos. 6,211,322 and 4,978,726.

The organosiloxanes, preferably (meth)acrylate-modified organosiloxanes, can preferably be crosslinked three-dimensionally by free radicals and can preferably cure thermally within a very short time with addition of peroxides, for example, or under the influence of high-energy radiation, for example UV radiation or electron beams, preferably to give mechanically and chemically durable layers. In the case of the use of UV light as radiation source, it may be preferable that the crosslinking is preferably effected in the presence of photoinitiators and/or photosensitizers, for example benzophenone, benzoin, α-hydroxyalkylphenone, acylphosphine oxide or derivatives thereof. Customary photoinitiators are described, for example, in “A Compilation of Photoinitiators Commercially available for UV today” (K. Dietliker, SITA Technology Ltd, London 2002).

Taking neither the pathway of merely material utilization nor the above-described pathway of deinking using exotic process auxiliaries (EP 0587000 A1) of cellulose-containing and/or polymeric siliconized carrier systems, the method according to the invention thus for the first time opens up a new and previously unexploited possibility for the physical reutilization, preferably for the complete physical reutilization, of siliconized papers, in particular of siliconized release liner systems based on cellulose.

In the context of this invention, release liners are understood to mean paper carriers which have the purpose of preventing a tacky surface from adhering prematurely. These papers are coated on one side or two sides with a silicone-based release agent. Release is understood to mean the separation of the coated paper carrier from a tacky material, such as from self-adhesive labels.

In particular, the method according to the invention may be used to enable individualized recovery of valuable natural substances (preferably the paper constituents, particularly the cellulose) which have been brought into intense contact with silicone materials.

Furthermore, the method according to the invention may preferably additionally also enable the recycling of the coating silicones, especially by chemical transformation thereof into siloxanes and/or silanes containing alkoxy groups. These chemical compounds, optionally in combination with other reactive silanes and/or silicones as well, can be processed further into a multiplicity of valuable derivative silicone products. This is a further, very significant advantage of the present invention.

A major advantage of the invention is that it is possible for the papers bearing the silicone coating to emerge from the desiliconization step essentially white or without discolouration, and so nothing stands in the way of the unrestricted reuse thereof in the field of paper production.

The method according to the invention and preferred embodiments of the method according to the invention are described in more detail below.

The first step (a) of the method according to the invention provides the treatment of least one siliconized paper by contacting it with at least one alcohol and at least one alkali metal alkoxide with introduction of heat.

This means that at least one alcohol together with at least one alkali metal alkoxide are allowed to act, with introduction of heat and preferably with introduction of mechanical energy, on the at least one siliconized paper to be treated. The at least one alcohol and the at least one alkali metal alkoxide are thus used together; in particular, the at least one siliconized paper is reacted by mixing together with the at least one alcohol and the at least one alkali metal alkoxide with introduction of heat.

Preferably, before carrying out the first step (a), the at least one siliconized paper may optionally also be shredded, for example with cutting tools.

The first step (a) serves for the desiliconization of the at least one siliconized paper, and so at least one desiliconized paper results from the first step (a). “Desiliconization” of the siliconized paper means that the silicone layer of the siliconized paper is removed from the paper.

All of the at least one desiliconized paper resulting from the first step (a) is then removed from the optionally previously neutralized reaction mixture in a second step (b).

That is to say that neutralization of the reaction mixture before all of the desiliconized paper is removed is optionally possible, but not mandatory.

According to a very particularly preferred embodiment, the method according to the invention is carried out in step a) with addition of ethanol and potassium methylate.

What also applies to the first step (a) is that the treatment is effected without removing from the reaction mixture any water that occurs.

Preferably, the first step (a) is effected with introduction of heat in a temperature range between 50° C. and 200° C., further preferably between 80° C. and 180° C., in particular between 80° C. and 120° C. This corresponds to a preferred embodiment of the invention. The introduction of heat may be effected by way of the customary methods known to those skilled in the art, in particular using a heating medium, for example via the reactor wall.

In the context of this invention, alkali metal alkoxide is preferably understood to mean compounds of the general formula:

[M⁺][OR⁻],
where
M is selected from the group consisting of Li, Na and K, preferably selected from the group consisting of Na and K
and
R is a linear, branched or cyclic alkyl radical, preferably having 1 to 10 carbon atoms, particularly preferably having 1 to 6 carbon atoms, very particularly preferably having 1 or 2 carbon atoms; according to a preferred embodiment of the invention, the at least one alkali metal alkoxide is accordingly selected from the abovementioned compounds.

At least one alkali metal alkoxide is used in the method according to the invention.

Particular preference is given to the use of potassium ethoxide, sodium ethoxide, potassium methoxide and/or sodium methoxide; potassium methoxide is especially preferred.

The known processes for the possible production of alkoxides include chloralkali electrolysis by the amalgam process, where sodium amalgam is reacted with alcohol [cf. for example Chemical and Engineering News 22, 1903-06 (1944)].

A further known method is for example the production of alkoxides from an alkali metal and an alcohol or from an alkali metal hydroxide and an alcohol. Alkoxide production from an alkali metal and a tertiary alcohol is known for example from DE-23 33 634 (Dynamit Nobel) or DE-26 12 642 (Degussa). Production of an alkoxide from an alkali metal hydroxide and a tertiary alcohol is likewise known. The first process variant requires the use of costly alkali metal and the second variant proceeding from alkali metal hydroxide requires that the water formed during the reaction be removed by distillation, thus necessitating correspondingly high thermal outlay.

According to the teaching of DE-A-33 46 131, alkali metal alkoxides may for example also be produced electrolytically from salts, where an electrolysis cell in which a cation exchange membrane separates the electrode spaces is used. DE-42 33 191.9-43 describes for example a process which enables production of an alkali metal alkoxide from a salt by electrodialysis.

Also described individually are processes for producing speciality alkoxides, for example the alkoxides of higher and/or polyhydric alcohols.

Alkoxides of higher and/or polyhydric alcohols are known for example to be producible in principle by transalcoholization, i.e. by substitution of the alkoxide radical of lower alkoxides ROM by reaction with higher alcohols R′OH (where R and R′ are alkyl radicals of different carbon chain lengths and M represents a metal cation) in a liquid reaction mixture at suitable temperature and pressure conditions. In the laboratory jargon this reaction is also referred to as “recooking”. The position of the equilibrium

ROM+R′OH [symbol] ROH+R′OM
depends on the acidity of the two alcohols, which decreases in the order methanol >primary >secondary >tertiary alcohols [R. T. McIver and J. A. Scott, J. American Chem. Soc. 96 (1973) 2706]. Accordingly, it is said that the production of the alkoxides of secondary alcohols in this way is possible only in exceptional cases and the production of the alkoxides of tertiary alcohols by transalcoholization is entirely unsuccessful [“Methoden der Organischen Chemie” (1963) Vol. 6/2, p. 13]. However, DE-1 254 612 and DE-27 26 491 (both Dynamit Nobel) disclose the production of alkoxides by recooking for higher alcohols too. GB-1 143 897 (Metallgesellschaft) describes for example the reaction of a monovalent alkali metal alkoxide with a C2 to C18 alcohol or phenol containing up to six hydroxyl groups, where the solvent used is an excess of monohydric alcohol and/or a hydrocarbon.

However, the recooking always leads to formation of the low-boiling alcohol ROH (for example methanol) which, for isolation of the desired alkoxide-optionally in addition to the unconverted higher alcohol R′OH—requires removal from the reaction product mixture in some cases with considerable thermal outlay.

Aside from these thermal equilibrium shifts, EP0776995 (B1) teaches for example a process for producing alkoxides under the influence of an electric field, where an alcohol is converted into the desired alkoxide by supplying metal ions and the metal ions themselves originate from the electrochemical decomposition of another alkoxide in the electric field; the alkoxide formation and decomposition are performed in chambers spatially separated by ion exchange membranes.

The at least one alkali metal alkoxide used in the first step (a) of the method according to the invention is preferably used in a total amount of 1% to 10% by mass, preferably of 2% to 7% by mass, particularly preferably of 3% to 6% by mass, based on the mass of the total silicone used in the reaction, which corresponds to the mass of all of the silicone with which the at least one siliconized paper is coated. This corresponds to a preferred embodiment of the invention.

The method according to the invention is carried out in the first step (a) preferably in the temperature range from 50° C. to 200° C., more preferably in the temperature range from 80° C. to 180° C., further preferably in the temperature range from 80° C. to 120° C., and over a period of preferably 1 to 12 hours, more preferably over a period of 2 to 8 hours, in each case preferably in the absence of solvent. This corresponds to a further particularly preferred embodiment of the invention.

According to a further preferred embodiment of the invention, the at least one alcohol used in the first step (a) of the method according to the invention is selected from the group consisting of linear, branched and cyclic C1 to C10 alkanols, with preference being given to the use of methanol, ethanol, 1-propanol, isopropanol, 1-butanol, 2-butanol, isobutanol, pentanols, hexanols, heptanols, octanols, nonanols and/or decanols, and/or the isomers thereof, particular preference being given to the use of methanol and/or ethanol, in particular ethanol.

The at least one alcohol used in the first step (a) of the method according to the invention is preferably used in a total amount of 10% to 200% by mass, preferably 20% to 100% by mass, particularly preferably 30% to 80% by mass, based on the mass of the total silicone used in the reaction, which corresponds to the mass of all of the silicone with which the at least one siliconized paper is coated. This corresponds to a further particularly preferred embodiment of the invention.

Ensuring good contacting, in particular mixing, of the at least one siliconized paper with the at least one alcohol and the at least one alkali metal alkoxide in the first step (a) of the method according to the invention is preferred and can have a preferably positive influence on the ease with which the dissolution process takes place.

Preferably, the reaction mixture resulting from the first step (a) and/or the at least one desiliconized paper removed in the second step (b) may be treated with at least one Brønsted acid. This corresponds to a further particularly preferred embodiment of the invention.

Preferably, the removed at least one desiliconized paper is treated using at least one Brønsted acid. This may be performed in particular to neutralize the alkalinity on the paper surface which the paper has acquired from the reaction mixture of the alcoholic alkoxide solution.

For this optional treatment of the at least one desiliconized paper, use is preferably made of at least one nonoxidizing Brønsted acid, particularly preferably at least one Brønsted acid diluted with water, the concentration of the diluted Brønsted acid in water preferably being between 10% and 50% by weight, more preferably between 15 and 40 percent by weight.

This may preferably be carried out in such a way that the at least one desiliconized paper, preferably the desiliconized paper which has been shredded or for example is present as whole paper webs, is brought into contact with at least one Brønsted acid.

This optional treatment may for example be effected in customary reactors, preferably in a reaction vessel with stirrer, such that it results in the at least one desiliconized paper being brought into contact with the at least one Brønsted acid. The liquid phase is preferably then separated from the thus treated, desiliconized paper, and said paper is preferably subjected to a subsequent wash with demineralized water, separated from the washing water phase and then transferred preferably into an industrial dryer, such as a drying oven, for the purpose of dehumidification. Such an optional procedure corresponds to a further particularly preferred embodiment of the invention.

In the case of a desiliconized paper which for example is present in the form of paper webs, the optional treatment of the at least one desiliconized paper which is still alkaline at the surface may be effected, in the context of a preferred embodiment of the invention, preferably in a roller mill by the desiliconized paper in question first being unrolled from a roller, pulled through a Brønsted acid immersion bath and guided downstream of the immersion bath preferably through a subsequent wash with demineralized water and then through a drying stage, preferably drying oven, in order to then be rolled up again on a roller. Such an optional procedure corresponds to a preferred embodiment of the invention.

In the optional treatment with at least one Brønsted acid, the desiliconized paper surface wetted with an alcoholic alkoxide solution undergoes neutralization in particular to the extent that a salt and an alcohol are formed from the alkoxide and the acid.

In the optional treatment with at least one Brønsted acid, particular preference is given to using Brønsted acids diluted with water which are able to dissolve the resulting salt of the Brønsted acid and preferably the alcohols ethanol or methanol originating from the preferred use of potassium ethoxide, sodium ethoxide, potassium methoxide and/or sodium methoxide, and in particular potassium methoxide. Acids for use with particular preference include diluted sulfuric acid (preferably 10% to 25% by weight in water), diluted perchloric acid (preferably 10% to 25% by weight in water) and/or diluted acetic acid (preferably 10% to 30% by weight in water).

As is understood by those skilled in the art, oxidizing acids, such as concentrated sulfuric acid, concentrated nitric acid, concentrated perchloric acid and concentrated sulfonic acids, in particular should be avoided for the direct treatment of the desiliconized paper, since these acids may possibly cause at least a colour impairment in the sense of a dark colouring, if not even destruction of the paper, due to oxidation of the cellulose in the paper.

Preferably, the reaction mixture separated from the at least one desiliconized paper is neutralized using at least one anhydrous Brønsted acid, which corresponds to a further particularly preferred embodiment of the invention. The at least one anhydrous Brønsted acid particularly suitable for this purpose is preferably selected from the group consisting of anhydrous inorganic acids and anhydrous organic acids, in particular selected from the group consisting of anhydrous sulfuric acid, anhydrous perchloric acid and anhydrous acetic acid. Such a procedure makes it possible to obtain preferably alkoxysiloxanes from the process according to the invention and corresponds to a further particularly preferred embodiment of the invention.

It also corresponds to a further particularly preferred embodiment of the invention if, before the at least one desiliconized paper is removed, the reaction mixture resulting from the first step (a) is neutralized using at least one Brønsted acid, which is preferably selected from nonoxidizing Brønsted acids, particularly preferably Brønsted acids diluted with water, and is in particular selected from the group consisting of diluted sulfuric acid, diluted perchloric acid and diluted acetic acid, the concentration of the diluted Brønsted acid in water preferably being between 10% and 50% by weight, more preferably between 15 and 40 percent by weight.

Furthermore, it may be preferable to clean the at least one desiliconized paper obtained, for example in order to make it salt- and acid-free. It therefore corresponds to a further particularly preferred embodiment of the invention if the at least one desiliconized paper obtained, preferably the desiliconized paper treated using at least one Brønsted acid, is washed, preferably with demineralized water.

Furthermore, it may be preferable to dry the desiliconized paper. It therefore corresponds to a further particularly preferred embodiment of the invention if the at least one desiliconized paper, preferably desiliconized paper treated using at least one Brønsted acid and in particular washed, is dried, preferably thermally and/or optionally by contacting it with at least one organic solvent.

The reaction in the first step (a) is effected without removing from the reaction mixture any water that occurs. No water is removed from the reaction mixture, preferably neither by the use of solvents that form azeotropes with water nor by the use of further dehydrating agents.

If the treatment in the first step (a) of the method according to the invention is thus performed without the use of water-binding silicic esters, in particular without use of tetraalkoxysilanes, then this corresponds to a further particularly preferred embodiment of the invention.

According to a further preferred embodiment of the invention, if desired the invention may also be carried out with use of a roller mill, this preferably involving unwinding the paper to be desiliconized from a roller in order to subject it to the treatment according to the first step (a) of the method according to the invention, and then to remove it from the reaction mixture according to the second step (b) of the method according to the invention, then to pull it preferably through a neutralization bath and a rinsing bath and preferably to roll up the thus obtained desiliconized paper again after passing through a drying zone on the other side of the roller mill.

In the context of a preferred embodiment, the present invention may, as already described above, provide the optional use of at least one anhydrous inorganic acid. In the case of the actual use of at least one anhydrous inorganic acid, the total addition amount thereof is preferably calculated such that stoichiometric equivalence based on the total alkoxide used is achieved.

In the context of a preferred embodiment, the present invention may, as already described above, provide the optional use of at least one anhydrous organic acid. In the case of the actual use of at least one anhydrous organic acid, a significant stoichiometric excess of acid based on total alkoxide used may preferably be selected. This is preferably measured up to 50% stoichiometric excess.

The use amount of the anhydrous organic acid that is optionally usable in the context of a preferred embodiment is therefore preferably thus selected such that it is in the range from stoichiometric equivalence to 50% stoichiometric excess, in each case based on total alkoxide used.

The use amount of the Brønsted acids diluted with water that are optionally usable in the context of a preferred embodiment is preferably selected such that it is in the range from stoichiometric equivalence to 50% stoichiometric excess, in each case based on total alkoxide used.

For the possibility that the paper to be treated is paper webs, as is the case in the context of a preferred embodiment, those skilled in the art will understand that only a few exploratory preliminary tests are required in order to determine, in a preferred manner, the total amount of diluted Brønsted acid needed for the neutralization of the paper webs resulting from the second step (b) according to the invention. Since such paper webs removed from the reaction mixture in the context of such a preferred embodiment are only wetted with an alcoholic alkoxide solution, their total amount of Brønsted acid diluted with water needed for alkoxide neutralization is naturally less than the total amount needed for the neutralization of the amount of alkoxide that, according to another embodiment of the invention, is needed for the neutralization of the alkoxide in a mixture with the desiliconized paper, preferably shredded paper.

The use of at least one solvent should preferably be provided especially when the amount of salt expected from an optional neutralization step stands in the way of easy filtration.

Suitable as optional solvents which would be usable with preference in an optional neutralization step are preferably those which themselves are chemically inert with regard to the reaction system and promote dilution or dispersion of the constituents of the optional neutralization. The at least one optional solvent is preferably selected from the group consisting of alkanes, alkyl aromatics and alcohols, particularly preferably selected from the group of the alkyl aromatics, in particular selected from the group consisting of toluene and xylenes.

In the context of the invention, it is possible in principle to recycle all silicones suitable for the coating of papers.

According to a preferred embodiment of the invention, the method is effected with supply of heat and/or, preferably and, with introduction of mechanical energy.

It is preferable if the treatment of the siliconized paper in the context of the method according to the invention is performed preferably between 50° C. and 200° C., more preferably between 80° C. and 180° C., in particular between 80° C. and 120° C.

According to a further particularly preferred embodiment of the invention, the first step (a) of the method according to the invention is effected with introduction of mechanical energy, the mechanical energy being able to be introduced in the customary manner known to those skilled in the art, preferably in the form of stirring energy or ultrasound.

On a production scale, stirred reactors (stirred tanks) which are commonplace within chemical engineering can preferably be used.

Likewise suitable for the introduction of mechanical energy are preferably all devices which for example allow the paper webs to be desiliconized, in particular in the form of paper rolls, to be moved translationally through a mixture consisting of at least one alcohol and at least one alkali metal alkoxide with introduction of heat, and therefore for example calenders may also be used successfully.

The method according to the invention may preferably be performed at standard pressure (1013.25 hPa), at reduced pressure, or else under elevated pressure, for example in order to achieve high heat treatment temperatures of up to 200° C. in pressure-resistant apparatuses.

The method according to the invention is preferably carried out at standard pressure, which corresponds to a particularly preferred embodiment of the invention.

According to another preferred embodiment of the invention, the treatment of the at least one siliconized paper in the first step (a) may be carried out at a pressure greater than 1013.25 hPa.

If desired, the silanes and/or siloxanes that are preferably provided with reactive alkoxy functions and are obtainable from the process according to the invention may be used again as adhesives and sealants for example in the form of polymerization-active masses, optionally also blended with further crosslinking silanes and/or siloxanes, and unfilled and/or filled with fillers.

As is understood by those skilled in the art, the respective type and chemical composition of the coating silicone used shapes the composition of the siloxanes containing alkoxy groups that are preferably obtained by the method according to the invention.

In the context of the present invention, the term “siloxane containing alkoxy groups” especially also relates to matter containing varying amounts of silanes or siloxanes containing alkoxy groups, such as alkoxytrimethylsilane, dialkoxydimethylsilane, dialkoxytetramethyldisiloxane, etc.

The removal of the desiliconized paper from the liquid phase may be performed by the customary methods, for example by filtration.

If, in the context of a preferred embodiment of the invention, for example paper webs to be desiliconized are treated by being passed through a calender, then in this case a preferred separation of the liquid phase from the paper web in the sense of a pressing and squeezing operation can preferably already be achieved by setting of the roller gap, which is preferably arranged directly downstream of a treatment bath to be passed through which consists of at least one alcohol and at least one alkali metal alkoxide. Such a procedure corresponds to a preferred embodiment of the invention.

Even further preferred embodiments of the method according to the invention are explained in more detail and/or illustrated by way of example below.

If, in the context of a purely exemplary preferred embodiment of the method according to the invention, for example a yellowish, lumpy release paper siliconized on one side with a coat weight of e.g. 1.5 g of radiation-curing silicone/m² of paper carrier is introduced with stirring into a matrix e.g. consisting of ethanol and potassium methylate, is heated e.g. to gentle reflux for 4 hours and is neutralized e.g. with an aqueous acetic acid solution, and the solid constituents are isolated by filtration e.g. using a fluted filter, are washed with several portions of demineralized water until acid- and salt-free and are dried e.g. by contacting with ethanol, then what can be obtained is a white, paper carrier (see Inventive Example 1) which is completely free of silicone, has excellent absorbency with respect to water and can be processed further to form all products which are obtained from cellulosic recycled materials in the paper industry.

The desiliconizing effect according to the invention, that is to say the detachment of the silicone layer from the paper carrier, can be demonstrated in the context of a further preferred embodiment of the invention preferably by infrared-spectroscopic analysis of the paper surface, since the band positions that are characteristic of the presence of silicones, at wavenumbers between 1020 cm-1 and 1099 cm 1, are very significantly smaller in the case of the paper desiliconized according to the invention than the corresponding bands for the siliconized paper, and moreover the paper desiliconized according to the invention preferably exhibits the band positions that are characteristic of the water bound to cellulosic OH groups, at between 3150 to approx. 3750 wavenumbers, whereas the siliconized paper only has a comparatively weak absorption at those positions.

In a further preferred embodiment of the invention, the digestion system consisting of at least one alcohol and at least one alkali metal alkoxide is contacted not just once, but instead multiple times with the sheetlike structures to be desiliconized, and in this way it is possible to control the concentration of the siloxane containing alkoxy groups in the digestion system. By using analytical methods such as ²⁹Si NMR spectroscopy, but also for example with the aid of viscosity measurements, it is then possible to characterize the siloxane containing alkoxy groups.

The chemical detachment, achievable according to the invention, of the silicone coating from a siliconized paper can preferably be promoted even further by preferably ensuring, in the context of a particularly preferred embodiment of the invention, during the heat treatment that the papers to be reutilized are moved in the sense of a translation through the digestion system consisting of at least one alcohol and at least one alkali metal alkoxide.

In accordance with this teaching, it is possible for example in the context of a further particularly preferred embodiment of the invention in the case of rolled papers to preferably also use a roller mill-type arrangement in order to perform the invention, by e.g. stretching the paper to be desiliconized, which is wound into a roll, onto a roller mill, unwinding it, and pulling the unwound paper through an immersion bath which consists of at least one alcohol and at least one alkali metal alkoxide and has a controllable temperature. As is clear to those skilled in the art, in such a preferred embodiment the unrolling speed, the length of the immersion bath and, derived therefrom, the effective contact time of the carrier system with the digestion system consisting of at least one alcohol and at least one alkali metal alkoxide, along with the temperature and further parameters, in this case determine the efficacy of the desiliconization procedure. If desired, it is possible in such a preferred embodiment for example after passage through the digestion system for the paper to preferably also be pulled through a rinsing bath, then optionally dried and rolled up again elsewhere on the roller mill.

As already mentioned further above, the method according to the invention preferably also makes it possible to provide alkoxysiloxanes. The alkoxysiloxanes obtainable according to the invention may preferably be used as starting materials for polymerization-active masses and then preferably as sealants and/or adhesives with addition of suitable crosslinking catalysts, optionally also blended with further crosslinking silanes and/or siloxanes, optionally filled with fillers and/or pigments and/or unfilled.

The alkoxysiloxanes obtainable according to the invention are furthermore also suitable for example as starting materials for the production of SiOC-bonded polyether siloxanes by transesterification with polyetherols in the presence of zinc acetylacetonate as catalyst, as disclosed in European patent application EP3438158 (B1).

If for example particular number-average siloxane chain lengths are desired prior to the optional further processing described here, the alkoxysiloxanes obtainable according to the invention may preferably also be subjected to a downstream, preferably acid-catalyzed, equilibration in order to establish the target chain lengths.

Likewise, it is preferably possible to convert the alkoxysiloxanes obtainable according to the invention e.g. into the corresponding siloxanes containing acetoxy groups for example by way of reaction in a reaction medium, comprising acetic anhydride, perfluoroalkanesulfonic acid (in particular trifluoromethanesulfonic acid) and preferably acetic acid, with continuous discharging of the respective acetic ester, as described in patent application EP 3663346 A1, and to likewise use these as reactive intermediates, such as for the production of SiOC-bonded polyether siloxanes or else as starting materials for polymerization-active masses.

The example which follows serves merely to further elucidate the present invention and does not constitute any restriction of the present invention whatsoever.

### EXAMPLE

Infrared spectroscopy was used as a means of characterizing the carrier surfaces. The measurements were performed on a Tensor 27 IR spectrometer from Bruker Optik GmbH, equipped with a MIRacle, Multiple Crystals CRY ATR unit from PIKE, provided with an ATR crystal (Ge-Performance Crystal Plate) utilizing the OPUS 7.2 analytical software.

### Example 1 (Inventive)

### Desiliconization of a Siliconized Release Paper

A 500 ml four-neck round-bottom flask equipped with a precision glass paddle stirrer, an internal thermometer and a reflux condenser on top was initially charged with 100 g of ethanol together with 5.0 g of potassium methoxide while stirring. 10.6 g of a siliconized release paper cut into pieces having a length of approx. 1 to 2 cm and a width of approx. 1 cm was then added and the mixture was heated to reflux temperature (approx. 80° C.) for 4 hours.

The reaction mixture was allowed to cool to 23° C. and 100 ml of a 25% by weight acetic acid was added with stirring and the mixture was left for 30 minutes. The desiliconized paper shreds were removed using a fluted filter (MN 615), rinsed with 4 portions of 100 ml of demineralized water and finally also with 50 ml of ethanol.

The thus isolated, white paper shreds were dried overnight at 23° C.

The surfaces both of the siliconized and the desiliconized paper were characterized using infrared spectroscopy.

The band positions that are characteristic in the infrared spectrum of the presence of silicones, at wavenumbers between 1020 cm-1 and 1099 cm-1, were very significantly smaller in the case of the paper desiliconized according to the invention than the corresponding bands for the siliconized release paper. Moreover, the release paper desiliconized according to the invention exhibited the band positions that are characteristic of the water bound to cellulosic OH groups, at between 3150 to approx. 3750 wavenumbers, whereas the siliconized release paper only had a comparatively weak absorption at those positions.

The desiliconized paper absorbed water droplets applied to its surface spontaneously and in a manner similar to blotting paper, whereas the siliconized paper repelled water drops without any wetting at all.

1. A method for the physical reutilization of siliconized papers, the method comprising:
(a): treating at least one siliconized paper by contacting it with at least one alcohol and at least one alkali metal alkoxide with introduction of heat to form a reaction mixture and at least one desiliconized paper, and without removing from the reaction mixture any water that occurs,
and then,
(b): removing the at least one desiliconized paper resulting from (a) from the reaction mixture, which has optionally been previously neutralized.

2. The method according to claim 1, wherein the at least one desiliconized paper which has been removed is treated with at least one Brønsted acid.

3. The method according to claim 1, wherein the reaction mixture after having been separated from the at least one desiliconized paper is neutralized using at least one anhydrous Brønsted acid selected from the group consisting of anhydrous inorganic acids and anhydrous organic acids.

4. The method according to claim 1, wherein, before said desiliconized paper is removed, said reaction mixture resulting from (a) is neutralized using at least one Brønsted acid.

5. The method according to claim 1, wherein the at least one desiliconized paper obtained from (b) is washed.

6. The method according to claim 1, wherein the at least one desiliconized paper is dried after (b), optionally by contacting it with at least one organic solvent.

7. The method according to claim 1, wherein (a) is effected with introduction of mechanical energy, the mechanical energy being introduced in the form of stirring energy or ultrasound.

8. The method according to claim 1, wherein (a) is effected with introduction of heat in a temperature range between 50° C. and 200° C.

9. The method according to claim 1, wherein the treatment in (a) is performed without water-binding silicic esters.

10. The method according to claim 1, wherein the at least one alkali metal alkoxide used in (a) conforms to the general formula [M⁺][OR⁻], where
M is selected from the group consisting of Li, Na and K, and
R is a linear, branched or cyclic alkyl radical.

11. The method according to claim 1, wherein the at least one alcohol used in (a) is at least one selected from the group consisting of linear, branched and cyclic C1 to C10 alkanols.

12. The method according to claim 1, wherein the at least one alcohol used in (a) is used in a total amount of 10% to 200% by mass based on a mass of the total silicone used in the reaction, which corresponds to a mass of all of the silicone with which the at least one siliconized paper is coated.

13. The method according to claim 1, wherein the at least one alkali metal alkoxide used in (a) is used in a total amount of 1% to 10% by mass based on a mass of the total silicone used in the reaction, which corresponds to a mass of all of the silicone with which the at least one siliconized paper is coated.

14. The method according to claim 1, wherein the treatment in (a) is carried out over a period of 1 to 12 hours.

15. The method according to claim 2, wherein the at least one Brønsted acid is selected from the group consisting of diluted sulfuric acid, diluted perchloric acid, and diluted acetic acid.

16. The method according to claim 3, wherein the at least one anhydrous Brønsted acid is selected from the group consisting of anhydrous sulfuric acid, anhydrous perchloric acid, and anhydrous acetic acid.

17. The method according to claim 5, wherein the at least one desiliconized paper is washed with demineralized water.

18. The method according to claim 6, wherein the at least one desiliconized paper is dried thermally.

19. The method according to claim 8, wherein the temperature range is between 80° C. and 120° C.

20. The method according to claim 9, where the treatment is effected without use of tetraalkoxysilanes.
